(19) United States
(12) Patent Application Publication
(10) Pub. No.: US 2016/0296948 A1
(43) Pub. Date: Oct. 13, 2016

(54) Nozzle

(71) Applicant: CHUAN JIING ENTERPRISE CO., LTD., Taichung City (TW)

(72) Inventor: Tien-Tsai Tseng, TAICHUNG (TW)

(21) Appl. No.: 14/682,590

(22) Filed: Apr. 9, 2015

(51) Int. Cl. B05B 1/00

(52) U.S. Cl. CPC B05B 1/00

(57) ABSTRACT

A nozzle includes a tubular body and a distributor. The tubular body includes an input end, an output end, and a channel leading to the output end from the input end. The distributor includes at least one rib in contact with the output end of the tubular body when the distributor is connected to the tubular body. Thus, exits are made between the distributor and the output end of the tubular body and separated by the ribs.

### BACKGROUND OF INVENTION

1. Field of Invention

The present invention relates to a pipe for conveying liquid and, more particularly, to a nozzle connected to such a pipe.

2. Related Prior Art

A conventional tank includes a buoy inserted therein and a cover for covering an opening thereof. A pipe is inserted in the tank through the cover to conduct liquid such as oil into the tank. A valve connected to the bottom of the cover is movable by the buoy floating on the liquid to block the opening to stop the liquid from entering the tank.

Liquid enters the tank fast, rushes the liquid that has already been in the tank, and produces a lot of bubbles. The bubbles cause the level of the liquid to fluctuate and tilt the buoy. The tilted buoy causes the valve to block the opening before the tank is filled with enough liquid.

The present invention is therefore intended to obviate or at least alleviate the problems encountered in prior art.

### SUMMARY OF INVENTION

It is the primary objective of the present invention to provide a nozzle to reduce the speed of liquid that travels through it.

To achieve the foregoing objective, the nozzle includes a tubular body and a distributor. The tubular body includes an input end, an output end, and a channel leading to the output end from the input end. The distributor includes at least one rib in contact with the output end of the tubular body when the distributor is connected to the tubular body. Thus, exits are made between the distributor and the output end of the tubular body and separated by the ribs.

Other objectives, advantages and features of the present invention will be apparent from the following description referring to the attached drawings.

### BRIEF DESCRIPTION OF DRAWINGS

The present invention will be described via detailed illustration of two embodiments referring to the drawings wherein:

FIG. 1 is an exploded view of a nozzle according to the first embodiment of the present invention;

FIG. 2 is a perspective view of the nozzle shown in FIG. 1;

FIG. 3 is a cross-sectional view of the nozzle shown in FIG. 1;

FIG. 4 is a cross-sectional view of a thank used with the nozzle shown in FIG. 1; and

FIG. 5 is a perspective view of a nozzle according to the second embodiment of the present invention.

### DETAILED DESCRIPTION OF EMBODIMENTS

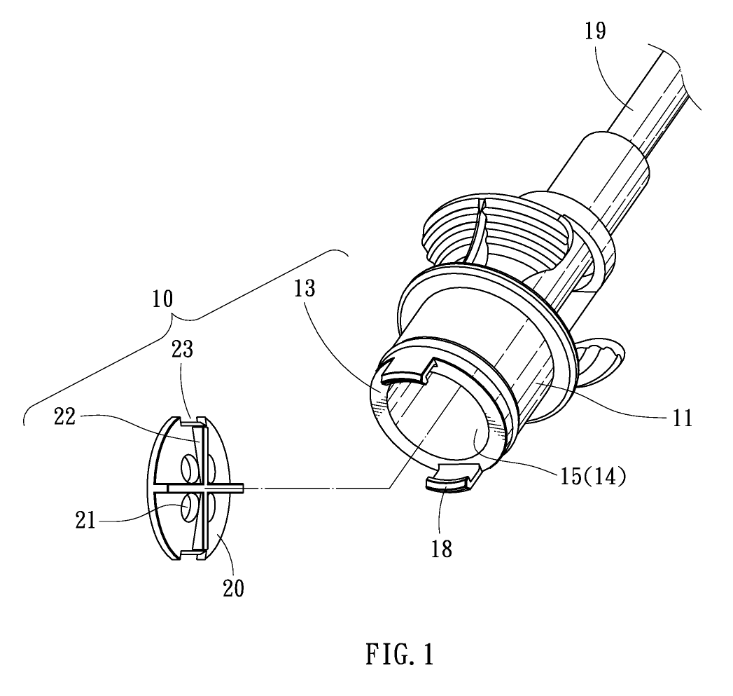

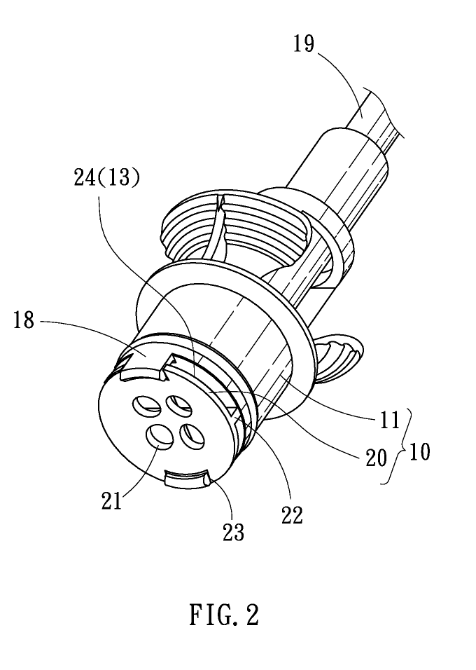

Referring to FIGS. 1 to 3, a nozzle 10 includes a tubular body 11 and a distributor 20 according to the first embodiment of the present invention. The nozzle 10 is connected to a pipe 19 in operation.

The tubular body 11 includes an input end 12, an output end 13 and a channel 14 leading to the output end 13 from the input end 12. The tubular body 11 further includes an insert 17. The input end 12 is located at the tip of the insert 17. The insert 17 is inserted in an end of the pipe 19 in operation. The tubular body 11 further includes two hooks 18 extending from the output end 13 of the tubular body 11. The hooks 18 and the output end 13 of the tubular body 11 are made one.

The channel 14 includes a large section 15 and a small section 16. The terms, “large” and “small”, are given regarding the diameter. The large section 15 is located near the output end 13. The small section 16 is located near the input end 12 and, more particularly, made in the insert 17. The sections 15 and 16 are in communication with each other.

The distributor 20 is made of a convex-concave configuration. The distributor 20 includes two opposite cutouts 23 at the edge thereof. The distributor 20 further includes four apertures 21 and four ribs 22. The ribs 22 together form a cruciform configuration. The ribs 22 are formed on a side of the distributor 20. The apertures 21 are separated from one another by the ribs 22.

The hooks 18 are aligned to the cutouts 23 before the distributor 20 is forced into the tubular body 11. The cutouts 23 receive the hooks 18. The hooks 18 hook the edge of the distributor 20, in the cutouts 23. Thus, the distributor 20 is connected to the tubular body 11, and the nozzle 10 is made. The ribs 22 are in contact with the output end 13 of the tubular body 11 thus four exits 24 are separated from each other by the ribs and made between the distributor 20 and the output end 13 of the tubular body 11.

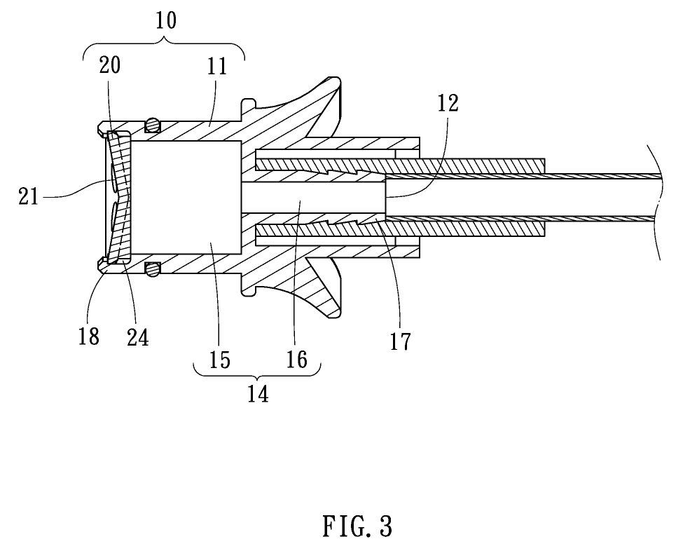

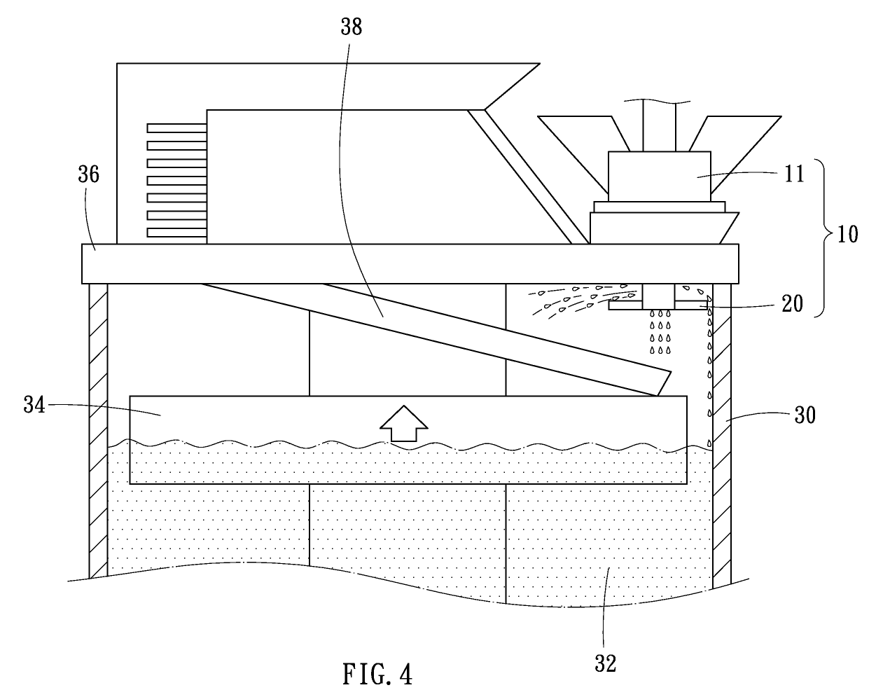

Referring to FIGS. 3 and 4, the nozzle 10 is inserted in a tank 30 through a cover 36. The tubular body 11 conveys liquid to output end 13 from the input end 12 in the channel 14. Liquid 32 is divided into four streams by the ribs 22 and sent out of the nozzle 10 via the exits 24. Thus, the liquid 32 enters the tank 30 slowly and travels down along an internal face of the tank 30, and hence produces a relatively small amount of bubbles. A buoy 34 remains to extend horizontally as it is lifted by the liquid 32. Thus, the buoy 34 does not move a valve 38 to block the tank 30 before the thank 30 is filled with enough of the liquid 32.

The distributor 20 includes a convex face directed towards the tubular body 11. The convex face of the distributor 20 includes a central apex for distributing the liquid 32. The apertures 21 are used to convey some of the liquid 32 to reduce the amount and speed of the liquid 32 that travels in the tank 30 through the exits 24.

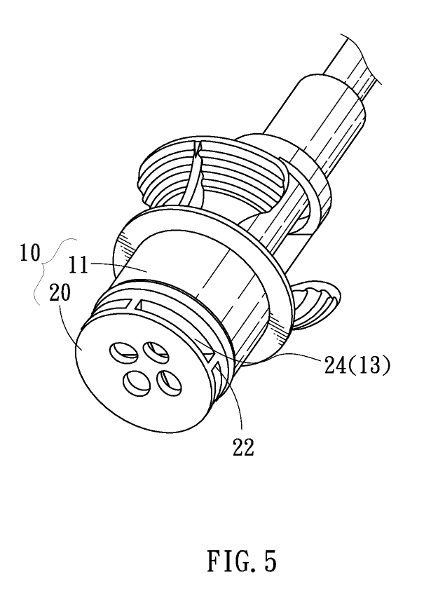

Referring to FIG. 5, there is a nozzle 10 according to a second embodiment of the present invention. The second embodiment is identical to the first embodiment except that the ribs 22 and the output end 13 are made one instead of made separately. The exits 24 remain.

The present invention has been described via the detailed illustration of the embodiments. Those skilled in the art can derive variations from the embodiments without departing from the scope of the present invention. Therefore, the embodiments shall not limit the scope of the present invention defined in the claims.

1. A nozzle including:
a tubular body including an input end, an output end, and a channel leading to the output end from the input end; and
a distributor including at least one rib in contact with the output end of the tubular body when the distributor is connected to the tubular body so that exits are made between the distributor and the output end of the tubular body and separated by the rib.

2. The nozzle according to claim 1, wherein the tubular body further includes hooks for hooking an edge of the distributor, wherein the hooks and the tubular body are made one.

3. The nozzle according to claim 2, wherein the distributor includes cutouts made at an edge thereof and used to receive the hooks.

4. The nozzle according to claim 1, wherein the rib and the output end are made one.

5. A nozzle including:
a tubular body including an input end, an output end, and a channel leading to the output end from the input end; and
a distributor including:
at least one rib in contact with the output end of the tubular body when the distributor is connected to the tubular body so that exits are made between the distributor and the output end of the tubular body and separated by the rib; and
at least one aperture in the vicinity of the rib.

6. The nozzle according to claim 5, wherein the tubular body further includes hooks for hooking an edge of the distributor, wherein the hooks and the tubular body are made one.

7. The nozzle according to claim 6, wherein the distributor includes cutouts made at an edge thereof and used to receive the hooks.

8. The nozzle according to claim 5, wherein the rib and the output end are made one.
